(19) United States
(12) Patent Application Publication
(10) Pub. No.: US 2009/0318232 A1
(43) Pub. Date: Dec. 24, 2009

(54) METHOD AND SYSTEM FOR CONTROLLING LOAD IN A COMMUNICATION NETWORK

(75) Inventors: John M. Harris, Glenview, IL (US); Thomas Casey Hill, Crystal Lake, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/144,895

(22) Filed: Jun. 24, 2008

(51) Int. Cl. A63F 13/12; H04B 7/00

(52) U.S. Cl. 463/42; 370/310

(57) ABSTRACT

The invention discloses a method and system for controlling load in a communication network having one or more communication devices. The method includes monitoring at least one communication resource parameters in the communication network. Further, the method includes changing difficulty level within a gaming application when one of the at least one communication resource parameters reaches a pre-determined threshold. One or more communication devices are involved in the gaming application.

### FIELD OF THE INVENTION

The invention generally relates to communication networks. More specifically, the invention relates to a method and system for controlling load in a communication network having one or more communication devices involved in a gaming application.

### BACKGROUND OF THE INVENTION

In recent years, users of communication devices often play games with other users in a communication network through a gaming application. Gaming applications typically require very low communication resource utilization, so that gaming experience is not severely affected when a high priority task is to be completed. Examples of high priority tasks may include but not limit to incoming calls, outgoing calls, messages and mails. Those skilled in the art would appreciate that several other tasks associated with the communication devices are also known and all such tasks that can be affected and are all within the scope of the invention.

Communication devices communicate with each other using network resources. When one or more users get involved in a gaming application, network resource usage may increase. This increase in the network resource usage affects the quality of service of both the gaming application and other high priority tasks. For example, the quality of service may deteriorate when a user attempts a call while playing a game on the communication network.

Also, if a plurality of users is involved in the gaming application, other users may also be affected due to network resource usage of the plurality of users involved in the gaming application. This may make overall gaming experience severely impaired and may downgrade the availability of the network resource usage for the high priority tasks.

### BRIEF DESCRIPTION OF FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the technology of the subject.

FIG. 1 is a block diagram illustrating a communication network (that is exemplary) in which various embodiments may function.

FIG. 2 is a flow diagram of a method for controlling load in a communication network, in accordance with an embodiment.

FIG. 3 is a flow diagram of a method for controlling load in the communication network, in accordance with another embodiment.

FIG. 4 is a flow diagram of a method for controlling load in the communication network by adjustment in cost of communication, in accordance with an embodiment.

FIG. 5 is a block diagram illustrating various components of a system for controlling load in the communication network, in accordance with an embodiment.

FIG. 6A, 6B, 6C are block diagrams illustrating various component of an altering module, in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

### DETAILED DESCRIPTIONS OF THE INVENTION

Before describing in detail embodiments that are in accordance with the technology of the subject, it should be observed that the embodiments reside primarily in combinations of a method and system for controlling load in a communication network having one or more communication devices involved in a gaming application. Accordingly, the apparatus components and method steps have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments described herein may be comprised of one or more conventional processors and unique stored program instructions that control the one or more processors to implement, in conjunction with certain non-processor circuits, some, most, or all of the functions of method and apparatus for controlling load in a communication network having one or more communication devices involved in a gaming application described herein. The non-processor circuits may include, but are not limited to, a radio receiver, a radio transmitter, signal drivers, clock circuits, power source circuits, and user input devices. As such, these functions may be interpreted as steps of a method to perform controlling load in a communication network having a one or more communication devices involved in the gaming application. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments provide a method and system for controlling load in a communication network having a plurality of communication devices. The method includes monitoring at least one communication resource parameters in the communication network. Further, the method includes changing difficulty level within a gaming application when one of the at least one communication resource parameters reaches a pre-determined threshold. One or more communication devices are involved in the gaming application.

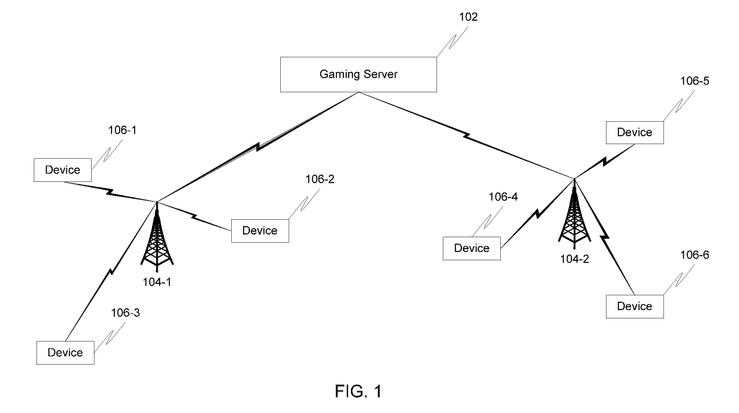

Referring to FIG. 1, a block diagram illustrating a communication network 100 (that is exemplary) in which various embodiments may function is illustrated. The communication network 100, for example, may be one of, but is not limited to a Global System for Mobile communication (GSM) system, a Code Division Multiple Access (CDMA), a Wireless Local Area Network (WLAN), a Local Area Network (LAN), a radio network, an Universal Mobile Telecommunication System (UMTS), a Worldwide Interoperability for Microwave Access (WiMax) system, a Wireless Fidelity (WiFi) system. The communication network 100 includes a gaming server 102, one or more base stations 104-n and one or more communication devices 106-n. The one or more communication devices 106-n are involved in a gaming application provided by the gaming server 102. The one or more communication devices 106-n are depicted as communication device 106-1 through 106-6. In an embodiment, the one or more communication devices 106-n may be one of, but is not limited to, a cellular phone, a Personal Digital Assistant (PDA), a laptop computer, and other type of communication devices. The gaming server 102 communicates with the one or more communication devices 106-n through the one or more base stations 104-n. Additionally, The one or more communication devices 106-n communicate with each other through the one or more base stations 104-n. To communicate within the communication network 100, the one or more communication devices 106-n use communication resources. The availability of various communication resources is determined by measuring the at least one communication resource parameters. Examples of a communication resource parameter may include, but are not limited to, a network loading in the communication network 100, a Radio Frequency (RF) condition in the network, a RF congestion condition, a RF condition variability condition, and a time of day.

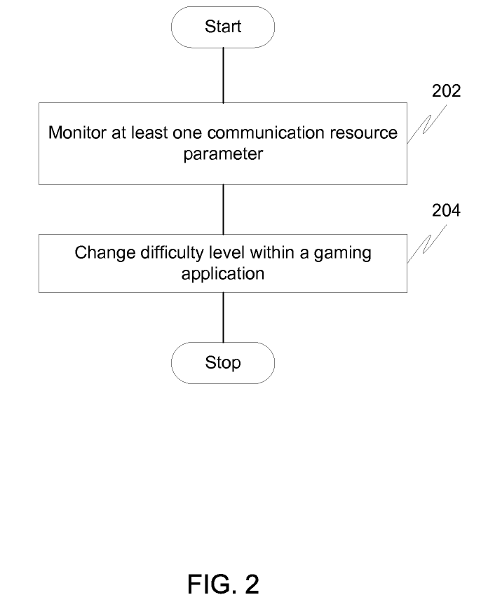

Turning now to FIG. 2, a flow diagram of a method of controlling load in the communication network 100, in accordance with an embodiment is illustrated. In order to maintain acceptable quality of services, the load on the communication network 100 needs to be controlled. The at least one communication resource parameter are monitored 202 to check the quality of services. The at least one communication resource parameter may correspond to the one or more communication devices 106-n. Alternatively, the at least one communication resource parameter may correspond to the one or more base stations 104-n. Further, the at least one communication resource parameter may correspond to the communication network 100. The values of the at least one communication resource parameter should satisfy a pre-determined threshold value to ensure an acceptable quality of services. The pre-determined threshold value may be defined manually. Additionally, the pre-determined threshold values may be defined based on the load on the communication network 100.

When the values of one of the at least one communication resource parameter reach a pre-determined threshold value, the difficulty level within a gaming application is changed 204. The gaming application may include one or more games. As a result of the change in the difficult level, the load in the communication network 100 is reduced. The difficulty level may be either increased or decreased depending on the nature of the gaming application. The change in the difficulty level reduces the time taken to complete a game. By way of an example, in a gaming application, a game ends when one or more players using one or more communication devices exhaust a pre-determined number of lives. In this scenario, to reduce the time taken by the one or more players to complete the game, the difficulty level in the game is increased. As a result, each player involved in the game exhaust their lives in less time, thereby, completing the game more quickly.

By way of another example, in a gaming application, a game ends when one or more communication devices involved in the game finish a task. In this scenario, the difficulty level may be decreased in the game, so that each communication device involved in the game is able to finish the task in less time, thereby ending the game. For example, a car racing game ends when one or more communication devices playing the car racing game reach a destination. In order to reduce the time taken by each communication device to complete the car racing game, the difficulty level of the car racing game is decreased. Decreasing the difficulty level of the car racing game reduces the time taken to reach the destination, thereby reducing the time taken to complete the game.

In an embodiment, the difficulty level is changed by the same amount for each of the one or more communication devices 106-n involved in a game. The change in the difficulty level balances the competitiveness of each of the one or more communication devices 106-n. For example, in a car racing game even if the at least one communication resource parameters of one of the one or more communication devices 106-n reaches a pre-determined threshold, the difficulty level is decreased for all the one or more communication devices 106-n involved in the car racing game. This would ensure that no competitive advantage is provided to any of the one or more communication devices 106-n.

In another embodiment, the difficulty level is changed based on the time spent by the one or more communication devices 106-n involved in the gaming application. For example, difficulty level of a communication device that is involved in the gaming application for the longest period of time is changed so that the communication device completes the game early. This would ensure that no particular communication device is involved in the gaming application for a long period of time, thereby consuming the network resources for an extended period of time.

In yet another embodiment, the difficulty level is changed based on the time left for the one or more communication devices 106-n to be involved in a game. For example, in a car racing game, difficulty level of a communication device that is nearest to the destination point is decreased so as to complete the game early. Also, by doing this, the gaming experience of the one or more communication devices 106-n involved in the game is not affected.

In another embodiment, the difficulty level is changed for each communication device in a first group of communication devices playing a first game. The difficulty level is changed based on utilization of various communication resources by one or more of the first group of communication devices and a plurality of second groups of communication devices. One or more of the plurality of second group of communication devices play a game different than the first game in the gaming application. For example, the gaming application may include three games: a first game, a second game, and a third game. For instance, the first game may have six communication devices. The second game may have ten communication devices. The third game may have eight communication devices. Further, in response to monitoring the at least one communication resource parameter there may be a need of changing difficulty level for two communication devices in the first game, for five communication devices in the second game, and for two communication devices in the third game. The difficulty level is changed for the game having maximum fraction of communication devices with the need to reduce the utilization of various communication resources. For instance, the difficulty level is changed for each of the five communication devices involved in the second game. This would ensure that gaming experience of the one or more communication devices 106-n involved in the one or more games would not get affected by the communication resource usage of the games having maximum fraction of communication devices with the need to reduce the utilization of various communication resources.

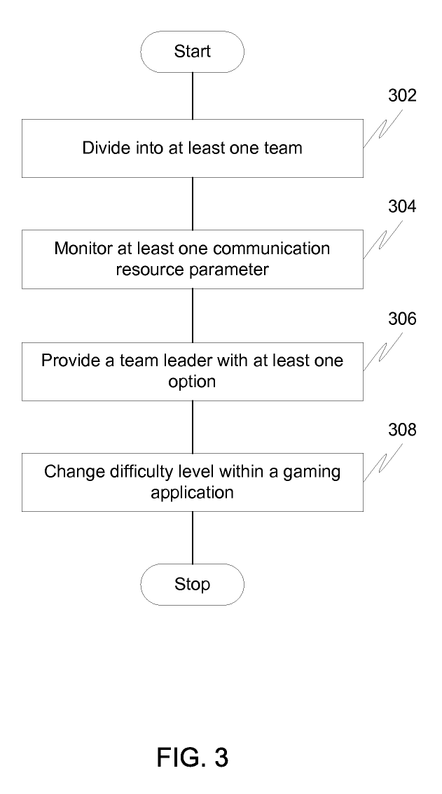

Moving now to FIG. 3, a flow diagram of a method for controlling load in the communication network 100, in accordance with another embodiment is illustrated. In this embodiment, the one or more communication devices 106-n involved in the gaming application are divided 302 into a plurality of teams. For instance, referring to FIG. 1, the communication device 106-1, the communication device 106-2, and the communication device 106-3 are in a first team and the communication device 106-1 is a team leader of the first team. Similarly, the communication device 106-4, the communication device 106-5, and the communication device 106-6 are in a second team and the communication device 106-4 is a team leader of the second team. Thereafter, the at least one communication resource parameters are monitored 304 for the one or more communication devices 106-n. This has been explained in conjunction with FIG. 2.

When the value of one of the at least one communication resource parameter reaches the threshold value, a team leader is provided 306 with one or more options. One or more options provided to the team leader may include, but are not limited to, quitting the game, changing the difficulty level of the game, ignoring other tasks, opting for additional advantages in the game, asking for additional powers in the game, putting the game on hold. Based on the option selected by the team leader from one or more options provided, the difficulty level within the gaming application is changed 308.

In an embodiment, the difficulty level is changed for equal number of communication devices in each of the plurality of teams involved in the gaming application. Referring to the previous example, each of the first team and the second team has three communication devices involved in the game. The difficulty level is changed for one communication device in each of the first team and the second team to balance the competitiveness in the game.

In another embodiment, the difficulty level is changed by dropping the one or more communication devices 106-n involved in the gaming application. Referring to the previous example, the difficulty level is changed for the first team and the second team by dropping one communication device from each team. For example, the communication device 106-2 from the first team and the communication device 106-6 from the second team may be dropped.

In yet another embodiment, the difficulty level is changed based on performance of the one or more communication devices 106-n involved in a game. A communication device that is performing the least well is dropped. Thus utilization of various communication resources by a communication device that is producing the least competition to other communication devices involved in the game is made “infinite”. For example, in a car racing game, a communication device at a last position in the car racing game may be dropped. Or the communication device that is performing the best is declared the winner.

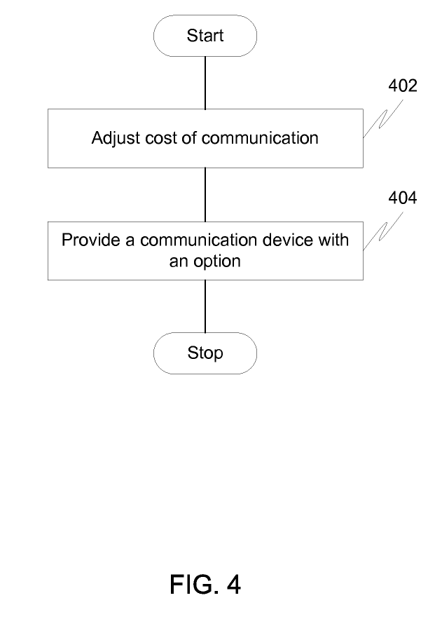

Turning now to FIG. 4, a flow diagram for controlling load in the communication network 100 by adjustment in cost of communication, in accordance with an embodiment is illustrated. In this embodiment, cost of communication required to be in the gaming application is adjusted 402. The adjustment of the cost of communication may be done by a service provider. The cost of communication may depend upon the at least one communication resource parameters. Cost of communication required to be in the gaming application is adjusted depending on various factors. For example, the cost of communication may be adjusted depending on time. By way of another example, the cost of communication may be increased during the day time and decreased during the night.

In response to adjusting the cost of communication, one or more options are provided 404 to the one or more communication devices 106-n. One or more options may include, but are not limited to, quitting the game, continuing with the game, changing the difficulty level of the game. The difficulty level is changed based on the option selected by the one or more communication devices 106-n from the one or more options provided.

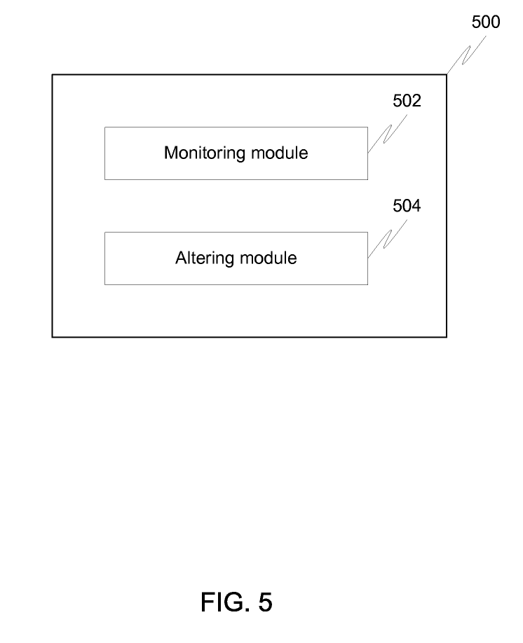

Moving to FIG. 5, a block diagram with various components of a system 500 for controlling load in the communication network 100, in accordance with an embodiment is illustrated. In order to maintain acceptable quality of services, the load on the communication network 100 needs to be controlled. Monitoring module 502 monitors at least one communication resource parameter to check the quality of services. This has been explained in conjunction with FIG. 2.

When the values of the at least one communication resource parameter reach a pre-determined threshold value, altering module 504 changes the difficulty level within a gaming application. As a result of the change in the difficult level, the load in the communication network is reduced. The altering module 504 may either increase or decrease the difficulty level depending on the nature of the gaming application, in order to reduce the time taken to complete the game. This has been explained in conjunction with FIG. 2.

In another embodiment, the altering module 504 is implemented on one or more of a service provider, a game server and the one or more communication devices 106-n. For example, if the altering module is implemented on a service provider, the service provider would be enabled to take the necessary action to control the load on the communication network 100.

Further, the system 500 may be implemented in one or more of centralized and distributed manner. For instance, the system 500 may be implemented in a distributed manner by implementing the system 500 on one or more of the one or more communication devices 106-n. Additionally, the system 500 may be implemented in a centralized manner by implementing the system 500 on a centralized server. The centralized server may be one of the service provider and the gaming server.

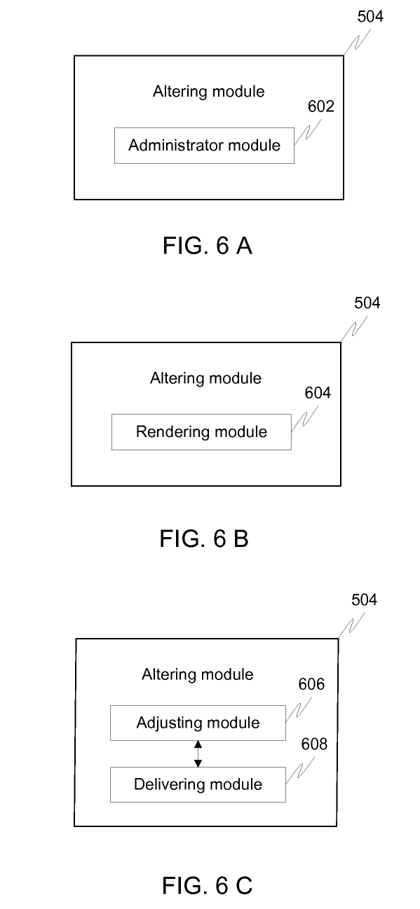

Moving now to FIG. 6A, a block diagram for a component of the altering module 504, in accordance with an embodiment is illustrated. In an embodiment, the one or more communication devices 106-n involved in the gaming application are divided into a plurality of teams. Further, the at least one communication resource parameters are monitored for the one or more communication devices 106-n. This has been explained in conjunction with FIG. 2. In response to monitoring, when the value of one of the at least one communication resource parameter reaches the threshold value, an administrator module 602 in the alerting module 504 provides a team leader with one or more options to change the difficulty level of the one or more communication devices 106-n in the team of the team leader. The difficulty level is changed based on the option selected by the team leader from the one or more options provided by the administrator module 602. This has been explained in conjunction with FIG. 3.

Turning to FIG. 6B, a block diagram of a component of the altering module 504 in accordance with another embodiment is illustrated. In this embodiment, the altering module 504 includes a rendering module 604. The rendering module 604 renders one or more options to the one or more communication devices 106-n involved in the gaming application. This has been explained in conjunction with FIG. 3.

Turning now to FIG. 6C, a block diagram of components of the altering module 504, in accordance with another embodiment is illustrated. In this embodiment, the altering module 504 includes an adjusting module 606. The adjusting module 606 adjusts cost of communication required to be involved in the gaming application for the one or more communication devices 106-n. The adjusting module 606 may be configured at the service provider level. The cost of communication may depend upon the at least one communication resource parameters.

In response to adjusting the cost of communication, a delivering module 608 provides one or more options to the one or more communication devices 106-n. The one or more options are provided in response to adjusting the cost of communication. This has been explained in conjunction with FIG. 4. Based on the option selected by the one or more communication devices 106-n from the one or more options provided the difficulty level is changed.

Various embodiments provide a method and an apparatus for controlling load in a communication network having one or more communication devices involved in a gaming application. The method offers users of the one or more communication devices to have better gaming experience and better quality of service for the high priority tasks. Moreover, the method may be implemented without the need to change the actual application code of the application server. The present method may act as a direct link between the gaming server and the communication network. Furthermore, the method provides users of the one or more communication devices with one or more options to act based on the choices of the user selected by them.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the tendency of this application and all equivalents of those claims as issued.

What is claimed is:

1. A method of controlling load in a communication network having a plurality of communication devices, the method comprising:
monitoring at least one communication resource parameter in the communication network; and
changing difficulty level within a gaming application when one of the at least one communication resource parameters reaches a pre-determined threshold, wherein at least one communication device is involved in the gaming application.

2. The method of claim 1, wherein changing the difficulty level reduces the load in the communication network.

3. The method of claim 1, wherein difficulty level is changed for each communication device involved in the gaming application by the same amount.

4. The method of claim 1, wherein the at least one communication device involved in the gaming application is a part of at least one team.

5. The method of claim 4, wherein difficulty level is changed for equal number of communication devices in each team involved in the gaming application.

6. The method of claim 4, wherein changing difficulty level comprises providing a team leader with at least one option to change difficulty level of at least one communication device in a team of the team leader.

7. The method of claim 1, wherein difficulty level is changed based on the time spent by a communication device involved in the gaming application.

8. The method of claim 1, wherein difficulty level is changed based on the time left for a communication device to be involved in a game.

9. The method of claim 1, wherein changing the difficulty level comprises:
adjusting cost of communication required to be involved in the gaming application; and
providing a communication device with an option to exit the gaming application in response to adjusting cost of communication.

10. The method of claim 1, wherein the gaming application comprises at least one game.

11. The method of claim 10, wherein difficulty level of each communication device in a first group of communication devices playing a first game is changed based on communication resource parameters of at least one of the first group of communication devices and a plurality of second groups of communication devices, wherein at least one second group of communication device plays a game different than the first game.

12. The method of claim 1, wherein the at least one communication resource parameter is selected from a list comprising:
a network loading in the network;
a Radio Frequency (RF) condition in the network;
a RF congestion condition;
a RF condition variability condition; and
a time of day.

13. The method of claim 1, wherein the network is one of a Global System for Mobile communication (GSM),), a Code Division Multiple Access (CDMA), a Wireless Local Area Network (WLAN), a Local Area Network (LAN), a radio network, an Universal Mobile Telecommunication System (UMTS), a Worldwide Interoperability for Microwave Access (WiMax) system, and a Wireless Fidelity (WiFi) system.

14. The method of claim 1, wherein changing difficulty level comprises dropping at least one communication device involved in the gaming application.

15. A system for controlling load in a communication network having a plurality of communication devices, the system comprising:
a monitoring module, the monitoring module configured to monitor at least one communication resource parameter in the communication network; and
an altering module, the altering module configured to change difficulty level within a gaming application when one of the at least one communication resource parameters reaches a pre-determined threshold, wherein at least one communication device is involved in the gaming application.

16. The system of claim 15, wherein the at least one communication devices involved in the gaming application is divided into at least one team.

17. The system of claim 16, wherein the altering module comprises an administrator module, the administrator module configured to provide a team leader with at least one options to change the difficulty level of the at least one communication devices in a team of the team leader.

18. The system of claim 15, wherein the altering module comprises a rendering module, the rendering module configured to render at least one option to at least one communication device involved in the gaming application.

19. The system of claim 15, wherein the altering module comprises:
an adjusting module, the adjusting module configured to adjust cost of communication required to be involved in the gaming application; and
a delivering module, the delivering module configured to provide a communication device with an option to exit the gaming application in response to adjusting cost of communication.

20. The system of claim 15, wherein an application server of a service provider comprises the altering module.

21. The system of claim 15, wherein a game server comprises the altering module.

22. The system of claim 15, wherein at least one communication devices comprises the altering module.
